(19) United States
(12) Patent Application Publication
(10) Pub. No.: US 2005/0065938 A1
(43) Pub. Date: Mar. 24, 2005

(54) Object oriented framework mechanism and method for product configuration selection determination

(75) Inventors: William R. Dorow JR., Rochester, MN (US); John William Hiltenbrand, Rochester, MN (US); Joseph Allen Huizenga, Rochester, MN (US); William Robert Taylor, Rochester, MN (US)

Correspondence Address: MARTIN & ASSOCIATES, LLC;IBM INTELLECTUAL PROPERTY LAW DEPARTMENT, DEPARTMENT 917, BUILDING 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/665,655

(22) Filed: Sep. 18, 2003

(51) Int. Cl. G06F 7/00

(52) U.S. Cl. 707/100

(57) ABSTRACT

An object oriented framework mechanism includes a platform independent product configuration selection model that defines a hierarchy of information that may be presented to a user for product configuration selection determination. The framework mechanism defines logic that specifies at least one relationship between items in the hierarchy of information. The framework operates on data stored external to the framework mechanism, thereby achieving a separation between the logic in the framework mechanism and the data upon which the logic in the framework mechanism operates. The framework mechanism is data driven, which means that adding data for a new product to the external data results in the framework mechanism autonomically adding the new product data to the hierarchy of information in the product configuration selection model.

### BACKGROUND OF THE INVENTION

1. Technical Field

This invention generally relates to the data processing field. More specifically, this invention relates to the management of product configuration information in a computer system.

2. Background Art

Since the dawn of the computer age, computer systems have become indispensable in many fields of human endeavor including engineering design, machine and process control, and information storage and access. One common application for computer systems is in the domain of configuration, which broadly applies to any problem where resources need to be allocated and configured. Examples of common configuration problems include the allocation of facilities at a convention, the layout of chips on a circuit board, and the configuration of a computer product in a computer manufacturing facility. In a configuration environment, there exists the need to display a hierarchy of information to a user so the user can make appropriate selections to define a desired configuration.

In the past, computers have been programmed with software to solve a variety of different configuration problems. Configuration software has typically been custom-developed according to the specific needs of a particular configuration environment. Because the overall performance parameters of different configuration environments may differ considerably, each different configuration application typically has its own custom, dedicated way of performing selection determination that is not easily adapted to any new or different application. Without a mechanism that can be readily customized to define a specific product configuration selection determination environment, the time required to program and maintain configuration software will be excessively long and expensive.

### DISCLOSURE OF INVENTION

According to the preferred embodiments, an object oriented framework mechanism includes a platform independent product configuration selection model that defines a hierarchy of information that may be presented to a user for product configuration selection determination. The framework mechanism defines logic that specifies at least one relationship between items in the hierarchy of information. The framework operates on data stored external to the framework mechanism, thereby achieving a separation between the logic in the framework mechanism and the data upon which the logic in the framework mechanism operates. The framework mechanism is data driven, which means that adding data for a new product to the external data results in the framework mechanism autonomically adding the new product data to the hierarchy of information in the product configuration selection model.

The foregoing and other features and advantages of the invention will be apparent from the following more particular description of preferred embodiments of the invention, as illustrated in the accompanying drawings.

### BRIEF DESCRIPTION OF DRAWINGS

The preferred exemplary embodiments of the present invention will hereinafter be described in conjunction with the appended drawings, where like designations denote like elements, and:

FIG. 1 is a block diagram of a computer system according to a preferred embodiment of the present invention;

FIG. 2 is a block diagram of prior art product configuration selection determination model;

FIG. 3 is a flow diagram of a prior art method for modifying the model in FIG. 2 to accommodate a new product;

FIG. 4 is a block diagram of a platform-independent product configuration selection determination framework in accordance with the preferred embodiments;

FIG. 5 is a flow diagram of a method for introducing a new product using the framework in FIGS. 1 and 4 in accordance with the preferred embodiments;

FIG. 6 is a class diagram showing relationships between classes in the framework;

FIG. 7 is a class diagram showing specific subclasses for the SelectionPage class of FIG. 6 for a specific example to illustrate the concepts of the preferred embodiments;

FIG. 8 is a class diagram showing specific subclasses for the SelectionGroup class of FIG. 6 for the specific example;

FIG. 9 is a class diagram showing specific subclasses for the SelectionItem class of FIG. 6 for the specific example; and

FIGS. 10 and 11 show different portions of a diagram that illustrates a hierarchy of information that may be represented by logic within the framework mechanism of the present invention.

### BEST MODE FOR CARRYING OUT THE INVENTION

The present invention relates to object oriented programming techniques. For those individuals who are not generally familiar with object oriented programming, the Overview section below presents many of the concepts that will help to understand the invention.

### 1. OVERVIEW

### Object Oriented Technology v. Procedural Technology

Object oriented programming is a method of implementation in which programs are organized as cooperative collections of objects, each of which represents an instance of some class, and whose classes are all members of a hierarchy of classes united via inheritance relationships. Object oriented programming differs from standard procedural programming in that it uses objects, not algorithms, as the fundamental building blocks for creating computer programs. This difference stems from the fact that the design focus of object oriented programming technology is wholly different than that of procedural programming technology.

The focus of procedural-based design is on the overall process that solves the problem; whereas, the focus of object oriented design is on how the problem can be broken down into a set of autonomous entities that can work together to provide a solution. The autonomous entities of object oriented technology are, of course, objects. Objects can be thought of as autonomous agents that work together to perform certain tasks. Said another way, object oriented technology is significantly different from procedural technology because problems are broken down into sets of cooperating objects instead of into hierarchies of nested computer programs or procedures.

Thus, a pure object oriented program is made up of code entities called objects. Each object is an identifiable, encapsulated piece of code that provides one or more services when requested by a client. Conceptually, an object has two parts, an external object interface and internal object data. In particular, all data is encapsulated by the object interface such that other objects must communicate with that object through its object interface. The only way to retrieve, process or otherwise operate on the encapsulated data is through the methods defined on the object. This protects the internal data portion of the object from outside tampering. Additionally, because outside objects have no access to the internal implementation of an object, that internal implementation can change without affecting other aspects of the program.

In this way, the object system isolates the requester of services (client objects) from the providers of services (server objects) by a well defined encapsulating interface. Thus, in the classic object model, a client object sends request messages (e.g., method calls) to server objects to perform any necessary or desired function. The message identifies a particular server object and specifies what method is to be performed by the server object, and also supplies any required parameters. The server object receives and interprets the message, and can then determine what service to perform.

Because all operations on an object are expressed as methods called from one object to another, methods can be called by objects in other processes. Objects that reside in one process and that are capable of calling methods on an object in another process (such as a process on a remote computer system) are known as distributed objects.

Many distributed object systems allow interaction between objects in remote locations over a communications link. In a distributed object system a “client object” in one location calls methods on a “server object” in another location, which may be a remote location. The client object—server object interactions form the basis for the distributed object system.

Another central concept in object oriented programming is the class. A class is a template that defines a type of object. A class outlines the makeup of objects that belong to that class. By defining a class, objects can be created that belong to the class without having to rewrite the entire definition for each new object as it is created. This feature of object oriented programming promotes the reusability of existing definitions and promotes efficient use of program code.

There are many computer languages that presently support object oriented programming techniques. For example, Smalltalk, Object Pascal, C++ and Java are all examples of programming languages that support object oriented programming to one degree or another.

The goal of using object oriented programming is to create small, reusable sections of program code known as objects that can be quickly and easily combined and re-used to create new programs. This is similar to the idea of using the same set of building blocks again and again to create many different structures. The modular and re-usable aspects of objects will typically speed development of new programs, thereby reducing the costs associated with the development cycle. In addition, by creating and re-using a group of well-tested objects, a more stable, uniform, and consistent approach to developing new computer programs can be achieved.

Although object oriented programming offers significant improvements over other programming types, program development still requires significant amounts of time and effort, especially if no preexisting objects are available as a starting point. Consequently, one approach has been to provide a program developer with a set of pre-defined, interconnected classes that create a set of objects. Such pre-defined classes and libraries are typically called object frameworks. Frameworks essentially provide a prefabricated structure for a working program by defining certain classes, class relationships, and methods that a programmer may easily use by appropriate subclassing to generate a new object oriented program.

### The Term Framework

There has been an evolution of terms and phrases which have particular meaning to those skilled in the art of OO design. However, the reader should note that one of loosest definitions in the OO art is the definition of the word framework. The word framework means different things to different people. Therefore, when comparing the characteristics of two supposed framework mechanisms, the reader should take care to ensure that the comparison is indeed “apples to apples.” As will become more clear in the forthcoming paragraphs, the term framework is used in this specification to describe an OO mechanism that has been designed to have core function and extensible function. The core function is that part of the framework mechanism that is not subject to modification by the framework purchaser (referred to herein as a “user”). The extensible function, on the other hand, is that part of the framework mechanism that has been explicitly designed to be customized and extended by the user. Note that the term “core function” is described herein as functions that cannot be modified by a user. However, because a function is a core function does not mean that a user is somehow prevented from modifying it. A user could use class replacement, for example, to replace core classes in a framework. However, the design of the framework intends that certain classes and class relationships remain undisturbed by the user, and these functions comprise the “core functions” of a framework. Thus, when core functions are described in a way that they “cannot be modified by a user”, this means that the core functions cannot be modified by a user within the design parameters of the framework.

### Object Oriented Frameworks

Object oriented frameworks are prefabricated structures of classes and class relationships that allow a programmer to extend the framework to build an object oriented program that performs desired functions. While in general terms an object oriented framework can be properly characterized as an object oriented (“OO”) solution, there is nevertheless a fundamental difference between a framework and a traditional OO program. The difference is that frameworks are designed in a way that permits and promotes customization and extension of certain aspects of the solution. In other words, framework mechanisms amount to more than just a solution to the problem. The mechanisms provide a living solution that can be customized and extended to address individualized requirements that change over time. Of course, the customization/extension quality of framework mechanisms is extremely valuable to purchasers (referred to herein as framework consumers) because the cost of customizing or extending a framework is much less than the cost of replacing or reworking an existing solution.

Therefore, when framework designers set out to solve a particular problem, they do more than merely design individual objects and how those objects interrelate. They also design the core function of the framework (i.e., the part of the framework that should not be subject to potential customization and extension by the framework consumer) and the extensible function of the framework (i.e., that part of the framework that is to be subject to potential customization and extension.).

### Notation

There is, as yet, no uniformly accepted notation for communicating object oriented programming ideas. The notation used in this specification is very similar to that known in the programming industry as Booch notation, after Grady Booch. Mr. Booch is the author of Object-Oriented Analysis and Design With Applications, 2nd ed. (1994), available from The Benjamin/Cummings Publishing Company, Inc. Use of Booch notation concepts within this specification should not be taken to imply any connection between the inventors and/or the assignee of this patent application and Mr. Booch or Mr. Booch's employer. The notational system used by Mr. Booch is more fully explained at Chapter 5, pp. 171-228 of the aforementioned book. The notational system used herein will be explained generally below. Other notational conventions used herein will be explained as needed.

### 2. DETAILED DESCRIPTION

An object oriented framework mechanism and method in accordance with the preferred embodiments defines a platform-independent product configuration selection model that includes an interface to external data that separates the data from the logic in the model. The framework includes logic that determines relationships between items in a hierarchy, and how those items are presented to a user. A platform-specific graphical user interface may be coupled to the framework to easily provide a data-driven solution for a particular platform.

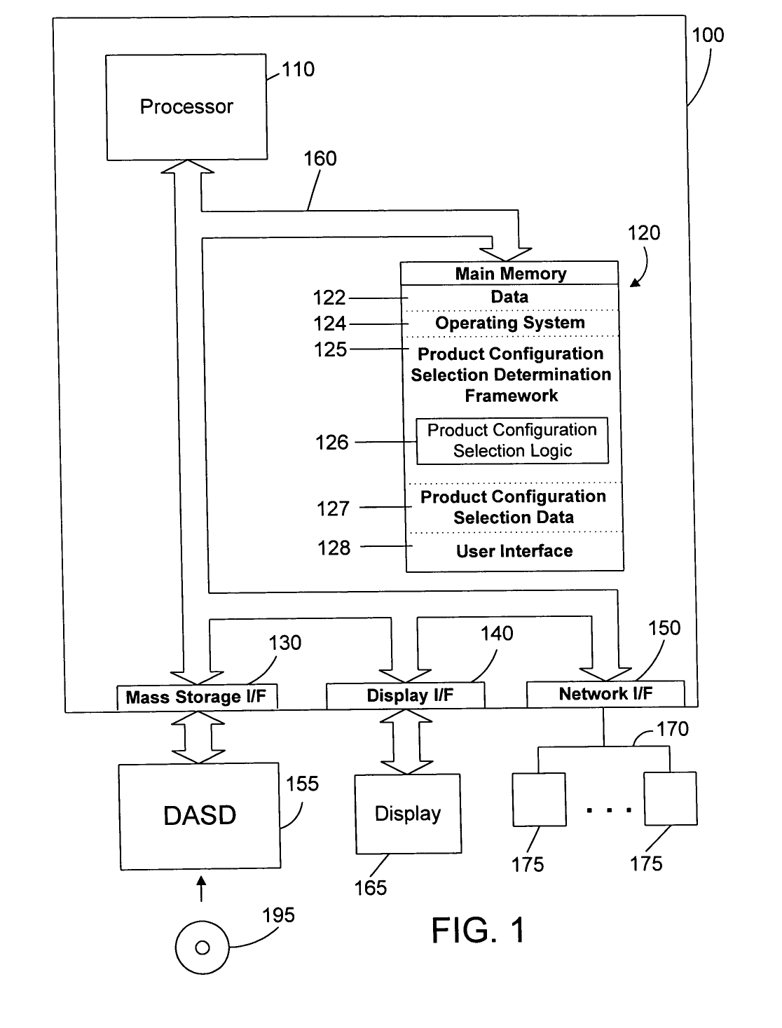

Referring to FIG. 1, a computer system 100 is one suitable implementation of a computer system (or apparatus) in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 122, an operating system 124, an object oriented product configuration selection determination framework 125, product configuration selection data 127, and a user interface 128. Product configuration selection determination framework 125 defines a product configuration selection model 126 that is platform-independent, and that contains logic 126 indicating relationships between items in a hierarchy of information that needs to be presented to a user for selection determination. The product configuration selection determination framework 125 provides a greatly improved system for performing product configuration because the logic 126 in the model has been divorced from the data 127 that the logic acts upon. Thus, product configuration selection data 127 includes specific data, while logic 126 specifies how that data is handled. This separation between logic and data allows the framework 125 to be data-driven, which means that a change to the product configuration selection data 127 will be detected by the logic in the model 126 and will be autonomically added to the hierarchy of information that needs to be presented to the user.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 122, operating system 124, framework 125, product configuration selection data 127 and user interface 128 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Data 122 represents any data that serves as input to or output from any program in computer system 100. Operating system 124 is a multitasking operating system known in the industry as OS/400; however, those skilled in the art will appreciate that the spirit and scope of the present invention is not limited to any one operating system.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 124. Operating system 124 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links.

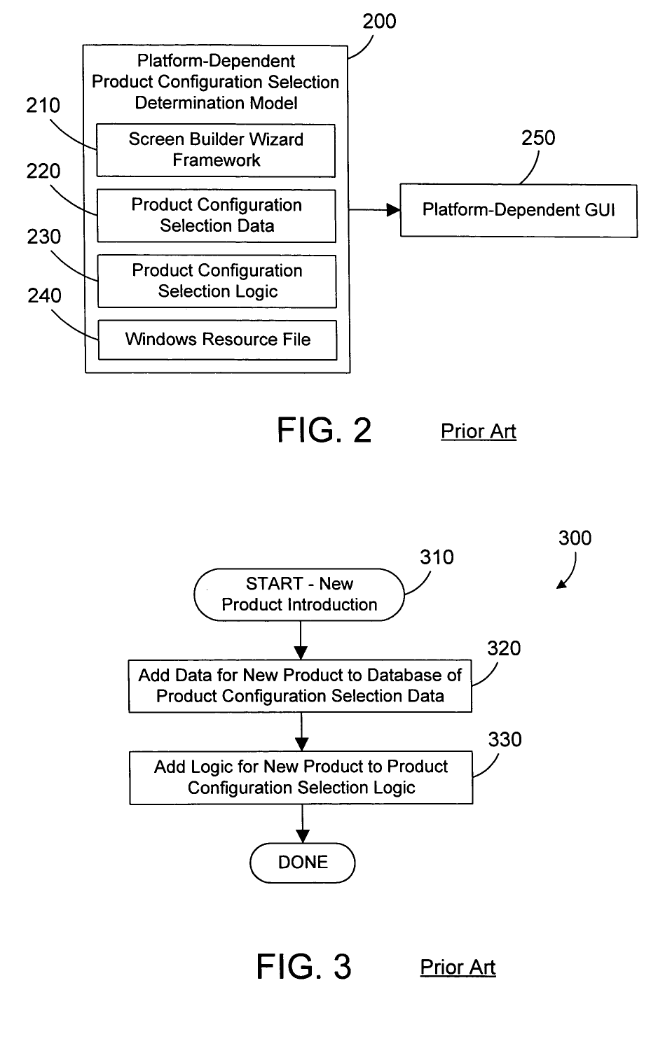

Referring now to FIG. 2, a prior art product configuration selection determination model 200 is shown. We assume this model is run on a Windows platform. Windows is a registered trademark of Microsoft Corporation. This model 200 includes a screen builder wizard framework 210, product configuration selection data 220, product configuration selection logic 230, and a Windows resource file 240. Model 200 is platform-dependent because it includes the Windows resource file 240 that is platform-specific. The model 200 interacts with a platform-dependent graphical user interface (GUI) 250 to present the hierarchy of information to a user. Windows resource file 240 typically defines each screen with specific controls and absolute positioning of controls and labels.

A method for adding a product to the system in FIG. 2 is shown as method 300 in FIG. 3. Method 300 begins when a new product is introduced, and therefore needs to be added to the model (step 310). Data for the new product is added to the product configuration selection data 220 (step 320). Logic for the new product is also added to the product configuration selection logic 230 (step 330). We see from method 300 that the process of adding a new product to the model 200 includes manually modifying both data 220 and logic 230. Once the data and logic have been modified to accommodate the new product, new screens are typically generated to include the newly-added information in the screens displayed to the user. The model 200 must then be re-compiled before it can be executed to present information regarding the new product to a user.

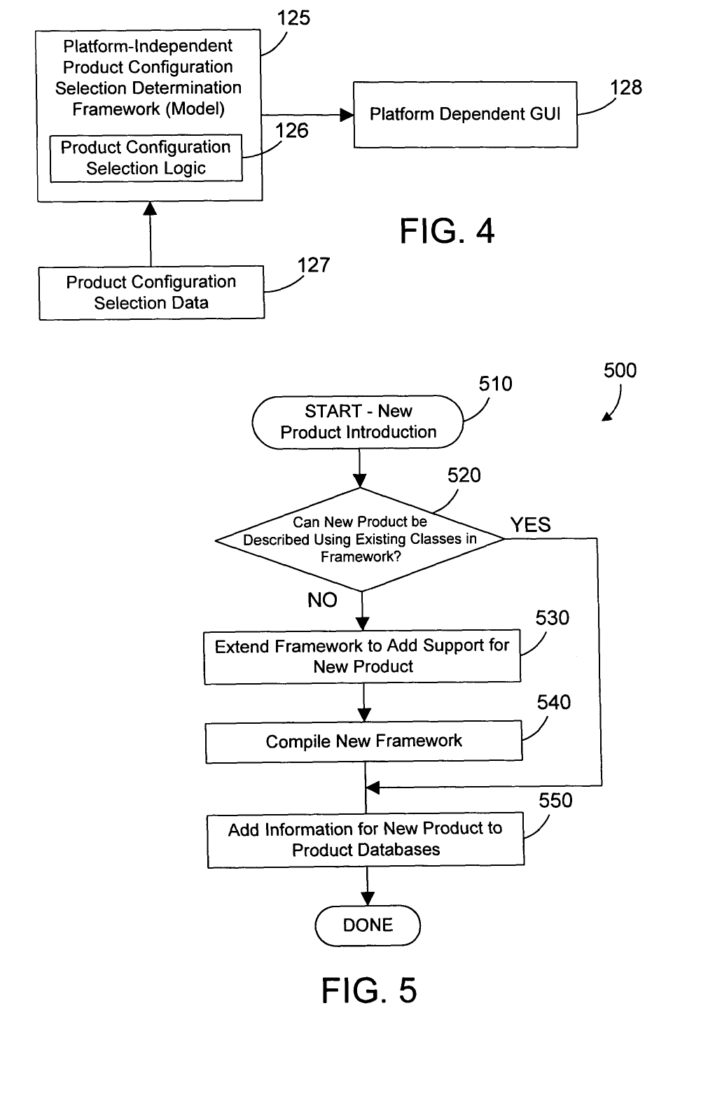

The preferred embodiments include significant improvements over the prior art as shown in FIGS. 2 and 3. Referring to FIG. 4, the product configuration selection data 127 is separate from the product configuration selection logic 126. In addition, the product configuration selection logic 125 is platform independent because it does not contain any platform-specific information (such as a Windows resource file). As a result, two great benefits are realized. First, the model can be data-driven. This means that data can be added to the product configuration selection data 127 that represents a new product, and the addition of the data will cause the framework 125 to include the data in its hierarchy of information that may be displayed to a user. Thus, it is possible to include a new product by simply adding the data for that new product in the product configuration selection data 127. The second benefit is the true platform-independence of framework 125. This platform independence allows the model implemented by framework 125 to be used with any GUI for any suitable platform.

FIG. 5 shows a method 500 for adding a new product to the model 125 in FIGS. 1 and 4. Method 500 begins when a new product needs to be added to the model (step 510). Method 500 determines whether the new product can be described using existing classes in the framework that defines the model (step 520). If so (step 520=YES), the information for the new product is added to the product configuration selection data 127 (step 550). Because the framework is truly data-driven, adding the new data causes the framework to include that data in the hierarchy of information to be displayed to a user. The classes included in the framework are preferably defined in a broad manner that will support the vast majority of new products. Thus, the branch (step 520=YES) in FIG. 5 will be taken in the majority of cases. If the existing classes in the framework do not fully support the description of the new product (step 520=NO), the framework is extended to add support for the new product (step 530), the new framework is compiled (step 540), and the information for the new product is added to the product configuration selection data 127 (step 550).

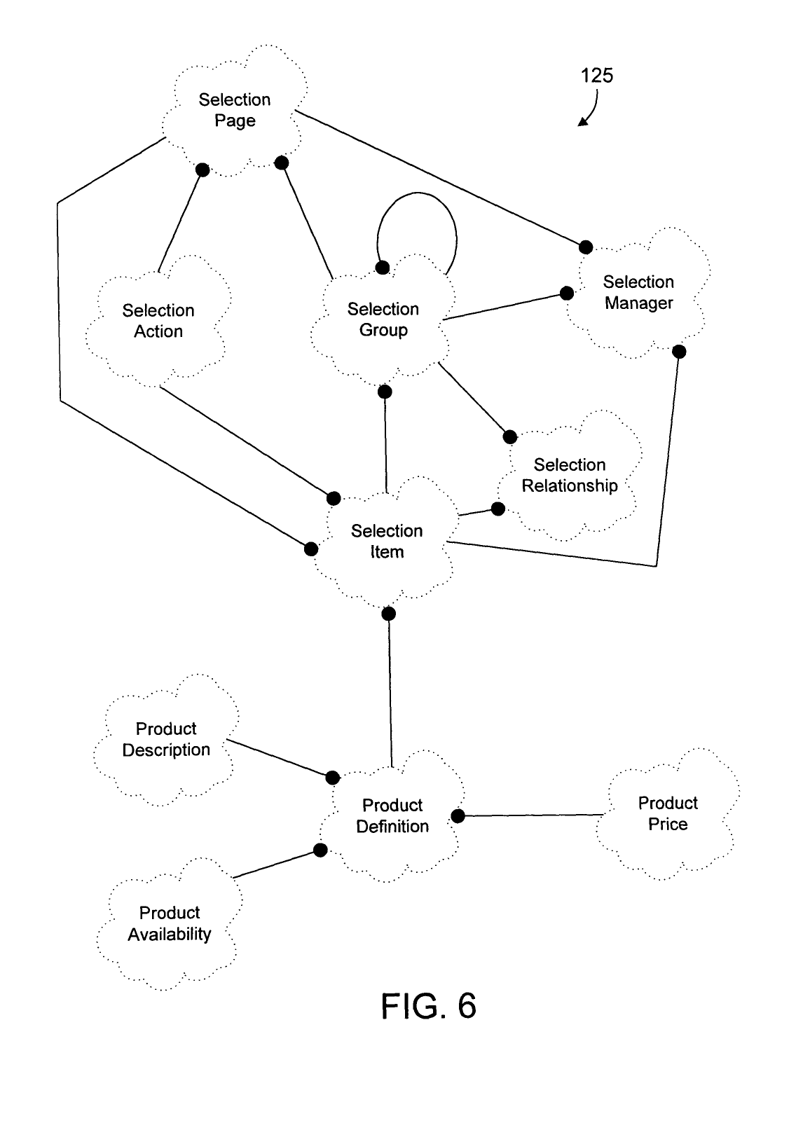

FIG. 6 shows a class diagram of one suitable implementation of framework 125 shown in FIGS. 1 and 4. A SelectionPage class manages the presentation of items within a page to assist in the navigation of selection determination by the user. Classes derived from the SelectionPage class allow for uniform page definitions, which might include such things as selection actions. The SelectionAction class manages consistent actions that can be performed by various selection pages, selection groups, and selection items. Classes derived from the SelectionAction class uniquely define the behavior of these actions on various elements within the model.

The SelectionGroup class manages the flow of selection groups and selection items to assist in the navigation of selection determinations made by the user. As part of its base function, the SelectionGroup class manages the minimum and maximum criteria for selection items along with other possible selection increments. Classes derived from the SelectionGroup class allow for unique selection determinations across selection items. For example, a SelectionGroup class could manage selection of memory based on memory size instead of selection of a part number. The SelectionManager class manages the selection of objects and the interactions that are performed across them.

The SelectionItem class presents information to the user for selection determination. As part of its base function, the SelectionItem class manages the minimum, maximum, and default selection criteria for a given item along with other possible selection increments. Classes derived from SelectionItem allow for actual product determination. For example, a SelectionItem could be a 256 MB memory card, even though the actual product representation could be a part number. The SelectionItem can thus be used to shield the user from some detailed product nomenclature.

The SelectionRelationship class manages interrelationships that exist between various levels of the objects in the framework, such as the effect that making a selection in one part of the selection model would have on other parts of the selection model. Classes derived from SelectionRelationship allow for unique relationship type definition such as pre-requests and co-requests. SelectionRelationship could also be used to perform product validation across various levels of the selection model.

The ProductDefinition class defines the product nomenclature and product information. Classes derived from ProductDefinition allow for various product representations, such as type/model number or part number nomenclature. The ProductDescription class provides a description of a product in a particular language. The ProductAvailability class defines the product availability according to the specific configuration type and geographical area (e.g., country). The ProductPrice class defines the product list price and in a particular currency.

The relationships between the classes in FIG. 6 is shown according to the arcs between classes. The black dot at the beginning of an arc indicates a “contains” relationship. Thus, according to FIG. 6, an instance of the SelectionPage class may contain one or more SelectionAction objects and one or more SelectionGroup objects. The other contains relationships in FIG. 6 are evident by the black dots, and are therefore not explained in more detail here.

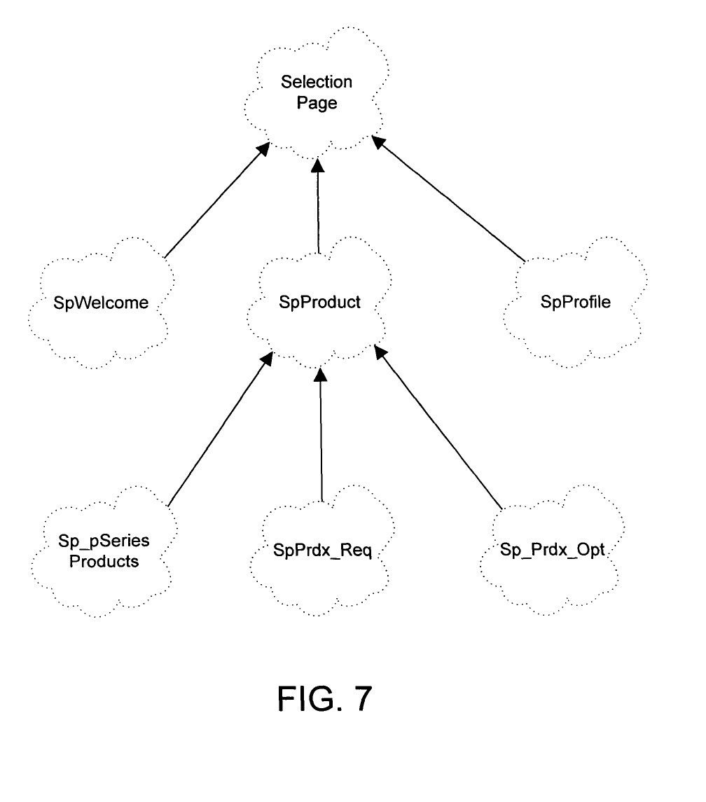

FIGS. 7-9 represent a particular implementation of the framework 125 in FIGS. 1 and 3 that is extended to define a product configuration selection model for computer systems sold by IBM Corporation. FIG. 7 is a class diagram that shows subclasses that are derived from SelectionPage in FIG. 6 for this specific example. The classes SpWelcome, SpProduct, SpProfile, Sp_pSeriesProducts, SpPrdx_Req, and Sp_Prdx_Opt are all concrete subclasses of the SelectionPage class in the framework. FIG. 7 thus illustrates how the SelectionPage class in the framework 125 may be extended to define suitable selection pages. The SpWelcome page is suitably customized to the usage of the application and may include security protocols. The SpProfile page requires interaction with potentially customer stored information. The SpProduct page contains an overall look and feel for product presentation to the user. Note that the three classes at the bottom of FIG. 7, namely Sp_pSeriesProducts, SpPrdx_Req, and Sp_Prdx_Opt, all preferably include methods for accessing corresponding data in the product configuration selection data 127.

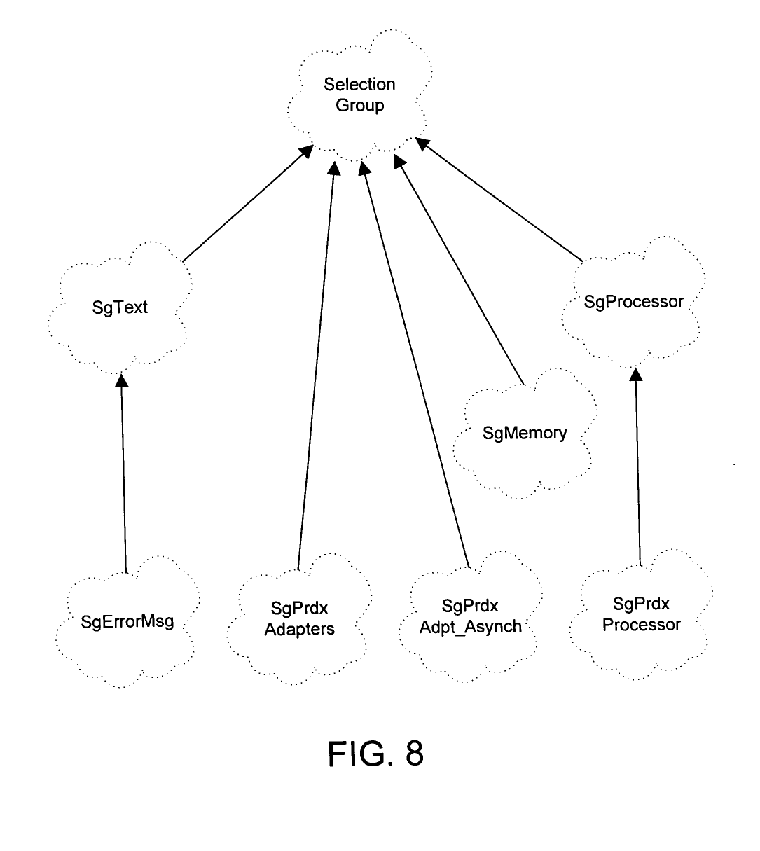

FIG. 8 is a class diagram that shows subclasses that are derived from SelectionGroup in FIG. 6 for this specific example. The classes SgText, SgErrorMsg, SgPrdxAdapters, SgPrdxAdpt_Asynch, SgMemory, SgProcessor, and SgPrdxProcessor are all concrete subclasses of the SelectionGroup class in the framework. FIG. 8 thus illustrates how the SelectionGroup class in the framework 125 may be extended to define suitable selection groups. The SgText class defines text information that may be presented to the user, and the SgErrorMsg class defines error messages that may be presented to the user. The SgMemory and SgProcessor classes define selection groups that allow the user to select the memory and processor, respectively. The classes at the bottom of FIG. 8, namely SgErrorMsg, SgPrdxAdapters, SgPrdxAdpt_Asynch, and SgPrdxProcessor all include methods for accessing corresponding data in the product configuration selection data 127.

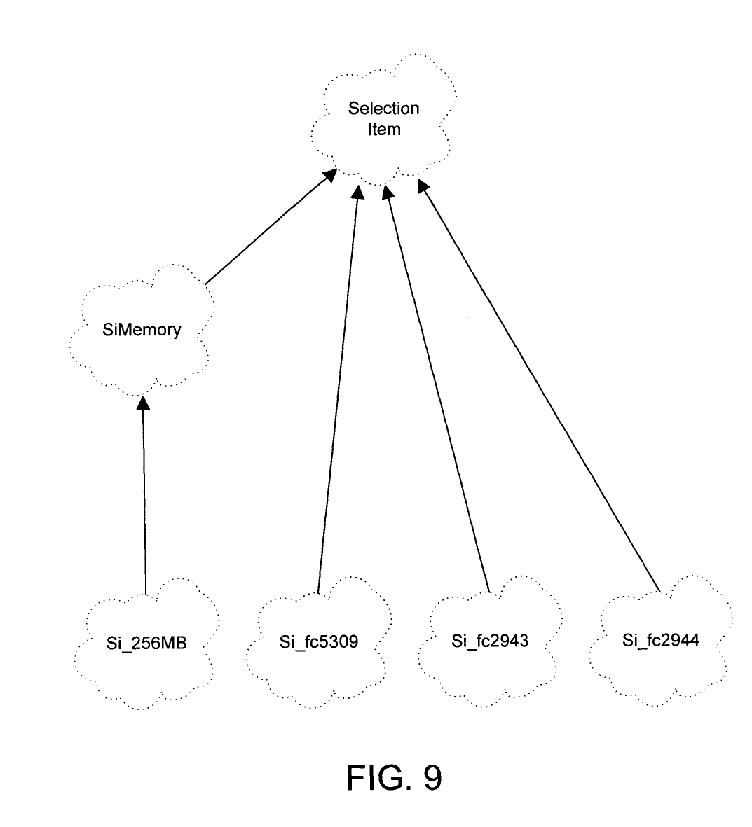

FIG. 9 is a class diagram that shows subclasses that are derived from SelectionItem in FIG. 6 for this specific example. The classes SiMemory, Si_{—}256 MB, Si_fc5309, Si_fc2943, and Si_fc2944 are all concrete subclasses of the SelectionItem class in the framework. FIG. 9 thus illustrates how the SelectionItem class in the framework 125 may be extended to define suitable selection items. The SiMemory class defines memory as a selection item. The classes at the bottom of FIG. 9, namely Si_{—}256 MB, Si_fc5309, Si_fc2943, and Si_fc2944, all include methods for accessing corresponding data in the product configuration selection data 127. Each of these four classes represents an actual part that may be selected when configuring a computer product in this specific example. Note that Si_{—}256 MB allows selecting a 256 MB memory card without knowing its part number. The remaining three classes are assumed to represent actual part numbers.

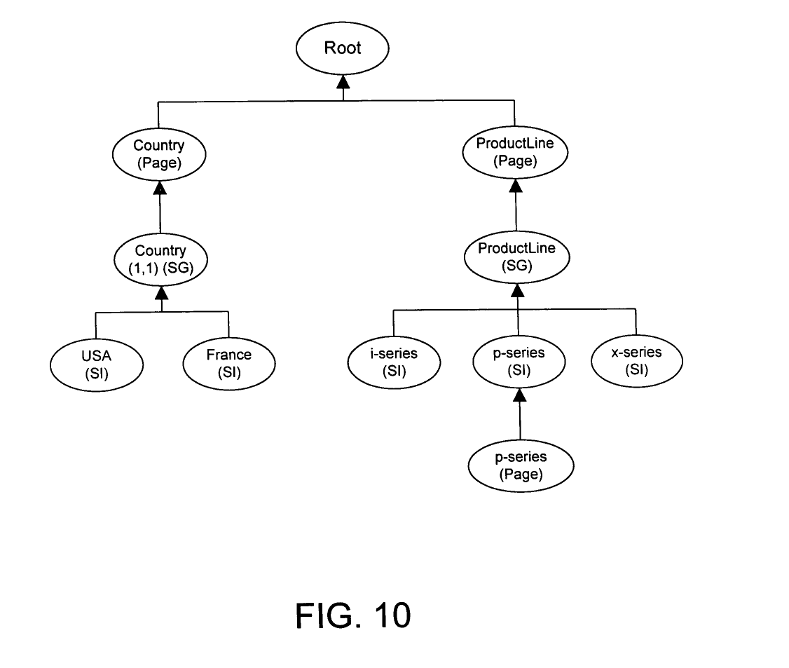

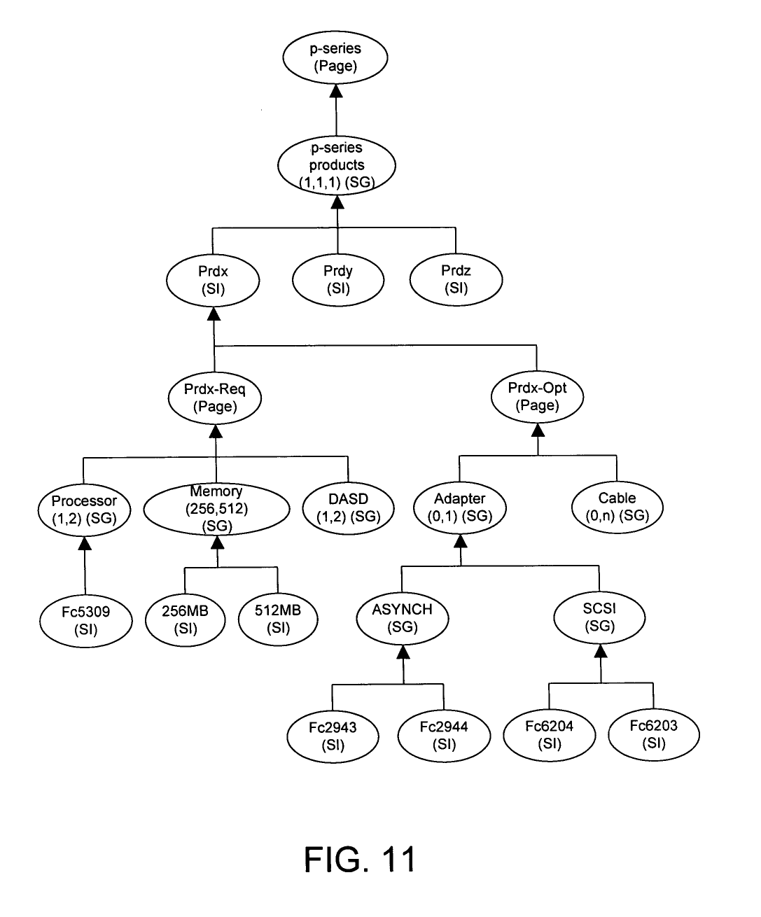

Referring now to FIGS. 10 and 11, a hierarchy 1000 of information represents a specific example of information that may be presented to a user using the framework 125. Referring first to FIG. 10, we assume a Root node has two sub-nodes that are pages, namely Country and ProductLine. The Country page has a corresponding Country selection group under it, with selection items USA and France being items that may be selected from the selection group Country. The ProductLine page has a corresponding ProductLine selection group under it, with selection items i-series, p-series, and x-series as members of the selection group. The p-series selection item has a p-series page under it.

Now we turn to FIG. 11 to see the hierarchy of information underneath the p-series page in FIG. 10. The p-series page has a selection group p-series products under it, with selection items Prdx, Prdy and Prdz as members of the selection group. The Prdx selection item has a Prdx-Req page and a Prdx-Opt page under it. The Prdx-Req page displays items that must be selected (required items), while the Prdx-Opt page displays items that may be optionally selected. The Prdx-Req page includes selection groups Processor, Memory and DASD under it. The Processor selection group includes a part number Fc5309 as a selection item, while the Memory selection group includes 256 MB and 512 MB parts as selection items. Note that the selection items 256 MB and 512 MB mask the part number nomenclature from the user.

The Prdx-Opt page includes two selection groups, Adapter and Cable. The Adapter selection group includes two other selection groups, namely ASYNCH and SCSI. The ASYNCH selection group includes two part numbers Fc2943 and Fc2944 as selection items, while the SCSI selection group includes two part numbers Fc6204 and Fc6203.

Note that the hierarchy of information in FIGS. 10 and 11 has only some of the information present to illustrate how such a hierarchy may be defined. For example, each selection item i-series and x-series in FIG. 10 would also have a corresponding tree of information below it. In addition, selection items Prdy and Prdz in FIG. 11 would also have corresponding trees of information below them. The hierarchy of information in FIGS. 10 and 11 is shown as an extremely simplified example.

One of the key benefits of the framework 125 is that it is truly data-driven. A simple example will illustrate. Let's assume that we have the hierarchy of information shown in FIGS. 10 and 11. Now let's assume a new computer system called the y-series is introduced by IBM, and needs to be added to the hierarchy of information. The ProductLine selection group in FIG. 10 populates its list of selection items from the product configuration selection data 127, which preferably resides in a database external to the framework. This means that adding data corresponding to a new y-series selection item to the list of selection items in the framework causes the framework to autonomically add the y-series selection item to the hierarchy of information. This is equally true for all the sub-information that relates to the y-series selection item. By adding the data for the new y-series computer system to the database that contains the product configuration selection data 127, the features corresponding to the y-series are autonomically added to the hierarchy of information in the framework. This illustrates the great power of the framework and the significant advantage of this data-driven framework when compared to prior art product configuration mechanisms.

Another significant advantage of the preferred embodiments is that the framework is truly platform-independent. A platform-dependent graphical user interface may use the framework to present the hierarchy of information to a user without affecting the underlying function of the framework. This allows using the framework on any suitable platform without affecting the framework's internal logic. This, indeed, is a significant feature of the framework. By providing the logic as core functions of the framework, a new product may be supported by simply adding the appropriate data for the new product to the database of product configuration selection data. No new code needs to be generated, the simple addition of data results in the addition of the new product to the hierarchy of information in the framework. In addition, in the rare case that existing classes do not support a new product, the framework allows its classes to be extended as needed. The framework thus provides a data-driven way to autonomically add new products, and yet also provides the flexibility of being extended, when required.

Note that the examples presented herein are extremely simplified to illustrate some of the pertinent aspects of the framework of the present invention. Many changes, variations, and enhancements to the embodiments herein are possible within the scope of the present invention. The present invention expressly extends to any and all implementations of an object oriented framework that is platform independent and data driven for a product configurator.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. An apparatus comprising:
at least one processor;
a memory coupled to the at least one processor;
an object oriented framework mechanism residing in the memory and executed by the at least one processor, the framework mechanism comprising a platform independent product configuration selection model that defines a hierarchy of information that may be presented to a user for product configuration selection determination and that defines logic that specifies at least one relationship between items in the hierarchy of information, the logic operating on data stored external to the framework mechanism, thereby achieving a separation between the logic in the framework mechanism and the data upon which the logic in the framework mechanism operates.

2. The apparatus of claim 1 further comprising a platform-dependent graphical user interface that uses the framework mechanism to display the hierarchy of information to the user.

3. The apparatus of claim 1 wherein the hierarchy of information includes at least one page.

4. The apparatus of claim 1 wherein the hierarchy of information includes at least one selection group.

5. The apparatus of claim 4 wherein the hierarchy of information includes at least one selection item in each selection group.

6. The apparatus of claim 1 wherein the logic operates on the external data, thereby causing a change in the external data to be autonomically reflected in the hierarchy of information in the platform independent product configuration selection model.

7. The apparatus of claim 1 wherein the framework mechanism comprises a plurality of extensible object oriented classes.

8. An apparatus comprising:
at least one processor;
a memory coupled to the at least one processor;
a database residing in the memory, the database including product configuration selection data;
an object oriented framework mechanism residing in the memory and executed by the at least one processor, the framework mechanism comprising a platform independent product configuration selection model that defines a hierarchy of information that may be presented to a user for product configuration selection determination and that defines logic that specifies at least one relationship between items in the hierarchy of information, the logic operating on the product configuration selection data in the database, thereby achieving a separation between the logic in the framework mechanism and the data upon which the logic in the framework mechanism operates, and thereby causing a change in the external data to be autonomically reflected in the hierarchy of information in the platform independent product configuration selection model.

9. A method for presenting product configuration information to a user, the method comprising the steps of:
(1) providing a data-driven object oriented framework mechanism that defines a hierarchy of information that may be presented to the user, the data-driven framework mechanism defining logic that specifies at least one relationship between items in the hierarchy of information, the data-driven framework mechanism operating on product configuration selection data stored external to the framework mechanism;
(2) updating the product configuration selection data to include data related to a new product; and
(3) the framework mechanism autonomically adding the new product to the hierarchy of information based on the data related to the new product.

10. The method of claim 9 further comprising the step of extending at least one class in the framework mechanism.

11. The method of claim 9 further comprising the step of providing a platform-dependent graphical user interface that uses the framework mechanism to display the hierarchy of information to a user on a specified platform.

12. The method of claim 9 wherein the hierarchy of information includes at least one page.

13. The method of claim 9 wherein the hierarchy of information includes at least one selection group.

14. The method of claim 13 wherein the hierarchy of information includes at least one selection item in each selection group.

15. A method for presenting product configuration information to a user, the method comprising the steps of:
(1) providing a data-driven object oriented framework mechanism that defines a hierarchy of information that may be presented to the user, the hierarchy of information including at least one page, at least one selection group, and at least one selection item in each selection group, the data-driven framework mechanism defining logic that specifies at least one relationship between items in the hierarchy of information, the logic operating on product configuration selection data stored external to the framework mechanism;
(2) updating the product configuration selection data to include data related to a new product; and
(3) the framework mechanism autonomically adding the new product to the hierarchy of information based on the data related to the new product.

16. The method of claim 15 further comprising the step of providing a platform-dependent graphical user interface that uses the framework mechanism to display the hierarchy of information to a user on a specified platform.

17. A program product comprising:
(1) an object oriented framework mechanism comprising a platform independent product configuration selection model that defines a hierarchy of information that may be presented to a user for product configuration selection determination and that defines logic that specifies at least one relationship between items in the hierarchy of information, the logic operating on data stored external to the framework mechanism, thereby achieving a separation between the logic in the framework mechanism and the data upon which the logic in the framework mechanism operates; and
(2) computer readable signal bearing media bearing the framework mechanism.

18. The program product of claim 17 wherein the signal bearing media comprises recordable media.

19. The program product of claim 17 wherein the signal bearing media comprises transmission media.

20. The program product of claim 17 further comprising a platform-dependent graphical user interface that uses the framework mechanism to display the hierarchy of information to the user.

21. The program product of claim 17 wherein the hierarchy of information includes at least one page.

22. The program product of claim 17 wherein the hierarchy of information includes at least one selection group.

23. The program product of claim 22 wherein the hierarchy of information includes at least one selection item in each selection group.

24. The program product of claim 17 wherein the logic operates on the external data, thereby causing a change in the external data to be autonomically reflected in the hierarchy of information in the platform independent product configuration selection model.

25. The program product of claim 17 wherein the framework mechanism comprises a plurality of extensible object oriented classes.

26. A program product comprising:
(1) an object oriented framework mechanism comprising a platform independent product configuration selection model that defines a hierarchy of information that may be presented to a user for product configuration selection determination and that defines logic that specifies at least one relationship between items in the hierarchy of information, the logic operating on the product configuration selection data in the database, thereby achieving a separation between the logic in the framework mechanism and the data upon which the logic in the framework mechanism operates, and thereby causing a change in the external data to be autonomically reflected in the hierarchy of information in the platform independent product configuration selection model; and
(2) computer readable signal bearing media bearing the framework mechanism.

27. The program product of claim 26 wherein the signal bearing media comprises recordable media.

28. The program product of claim 26 wherein the signal bearing media comprises transmission media.
